(19) United States
(12) Patent Application Publication
(10) Pub. No.: US 2016/0364185 A1
(43) Pub. Date: Dec. 15, 2016

(54) INFORMATION PROCESSING APPARATUS, NON-TRANSITORY COMPUTER READABLE MEDIUM, AND INFORMATION PROCESSING METHOD

(71) Applicant: FUJI XEROX CO., LTD., Tokyo (JP)

(72) Inventor: Kiyoaki OKAMOTO, Kanagawa (JP)

(73) Assignee: FUJI XEROX CO., LTD., Tokyo (JP)

(21) Appl. No.: 14/957,744

(22) Filed: Dec. 3, 2015

(30) Foreign Application Priority Data
Jun. 12, 2015 (JP) 2015-118793

(51) Int. Cl. G06F 3/12; H04N 1/44

(52) U.S. Cl. CPC G06F 3/126; H04N 1/4413; G06F 3/1205; G06F 3/1273; G06F 3/1285; H04N 2201/0094

(57) ABSTRACT

An information processing apparatus includes a first extracting unit, a second extracting unit, a third extracting unit, and a selecting unit. The first extracting unit extracts a history concerning non-personal use of an image processing apparatus. The second extracting unit extracts, from a schedule of users who use the image processing apparatus, combinations of users who will not use the image processing apparatus and time periods in which the combinations occur. The third extracting unit extracts, with the history and for each of the combinations of users, a use frequency or a use time in each of time periods of past use of the image processing apparatus. The selecting unit selects from the schedule a time period in which the use frequency or the use time satisfies a predetermined condition as a time period suitable for personal use of the image processing apparatus.

### CROSS-REFERENCE TO RELATED APPLICATIONS

This application is based on and claims priority under 35 USC 119 from Japanese Patent Application No. 2015-118793 filed Jun. 12, 2015.

### BACKGROUND

### Technical Field

The present invention relates to an information processing apparatus, a non-transitory computer readable medium, and an information processing method.

### SUMMARY

According to an aspect of the invention, there is provided an information processing apparatus including a first extracting unit, a second extracting unit, a third extracting unit, and a selecting unit. The first extracting unit extracts a history concerning non-personal use of an image processing apparatus. The second extracting unit extracts, from a schedule of users who use the image processing apparatus, combinations of users who will not use the image processing apparatus and time periods in which the combinations occur. The third extracting unit extracts, with the history and for each of the combinations of users, a use frequency or a use time in each of time periods of past use of the image processing apparatus. The selecting unit selects from the schedule a time period in which the use frequency or the use time satisfies a predetermined condition as a time period suitable for personal use of the image processing apparatus.

### BRIEF DESCRIPTION OF THE DRAWINGS

An exemplary embodiment of the present invention will be described in detail based on the following figures, wherein:

FIG. 1 is a conceptual module configuration diagram of a configuration example of the exemplary embodiment;

FIG. 2 is an explanatory diagram illustrating a system configuration example using the exemplary embodiment;

FIG. 3 is an explanatory diagram illustrating a data structure example of a user table;

FIG. 4 is an explanatory diagram illustrating a data structure example of a use frequency table;

FIG. 5 is an explanatory diagram illustrating a data structure example of a schedule table;

FIG. 6 is an explanatory diagram illustrating a data structure example of an image processing apparatus table;

FIG. 7 is a flowchart illustrating a processing example according to the exemplary embodiment;

FIG. 8 is a flowchart illustrating a processing example according to the exemplary embodiment;

FIG. 9 is a flowchart illustrating a processing example according to the exemplary embodiment;

FIG. 10 is an explanatory diagram illustrating a processing example according to the exemplary embodiment;

FIG. 11 is an explanatory diagram illustrating a data structure example of a use frequency related information table;

FIG. 12 is an explanatory diagram illustrating a processing example according to the exemplary embodiment;

FIG. 13 is an explanatory diagram illustrating a data structure example of a use time related information table;

FIG. 14 is an explanatory diagram illustrating a processing example according to the exemplary embodiment;

FIG. 15 is an explanatory diagram illustrating a data structure example of an image processing apparatus use frequency table;

FIG. 16 is an explanatory diagram illustrating a data structure example of a work arrival and departure information table;

FIG. 17 is an explanatory diagram illustrating a processing example according to the exemplary embodiment; and

FIG. 18 is a block diagram illustrating a hardware configuration example of a computer that realizes the exemplary embodiment.

### DETAILED DESCRIPTION

An example of an exemplary embodiment for realizing the present invention will be described below based on the drawings.

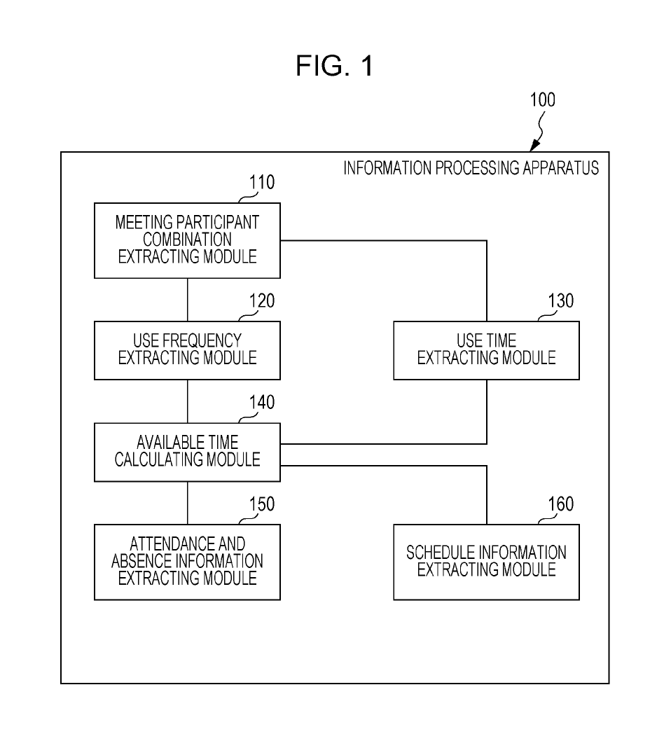

FIG. 1 illustrates a conceptual module configuration diagram of a configuration example of the exemplary embodiment.

In general, modules refer to logically separable components of software (a computer program), hardware, or the like. Modules in the exemplary embodiment, therefore, refer not only to modules in a computer program but also to modules in a hardware configuration. Thus, description of the exemplary embodiment will cover a computer program (a program for causing a computer to execute respective procedures of the modules, a program for causing a computer to function as respective units of the modules, or a program for causing a computer to realize respective functions of the modules), a system, and a method for causing components to function as the modules. For the convenience of description, expressions such as “storing (something)” and “causing (an object) to store (something)” and equivalents thereof will be used. When the exemplary embodiment is implemented as a computer program, these expressions mean causing or controlling a storage device to store (something). Further, the modules may correspond one-to-one to the functions. In implementation, a single module may be configured by a single program, or plural modules may be configured by a single program. Conversely, a single module may be configured by plural programs. Further, plural modules may be executed by a single computer, or a single module may be executed by plural computers in a distributed or parallel environment. One module may include another module. Further, the term “connection” will hereinafter be used to refer to logical connection (such as transmission and reception of data, transfer of instructions, and reference of data) as well as physical connection. The term “predetermined” refers to that something is determined prior to a target process, and the term will be used to refer not only to that something is determined before the start of the processing according to the exemplary embodiment, but also to that something is determined after the start of the processing according to the exemplary embodiment at a time before the target process in accordance with the state or status at or up to the time. If there are plural “predetermined values,” the values may be different from one another, or two or more of the values (which obviously include all of the values) may be the same. Further, a description indicating that “if A is true, B is performed” will be used to denote that “whether or not A is true is determined, and B is performed if it is determined that A is true,” except when the determination of whether or not A is true is unnecessary.

Further, a system or an apparatus refers to a configuration in which plural computers, hardware components, apparatuses, or the like are connected by a communication unit such as a network (including one-to-one communication connection) and also a configuration realized by a single computer, hardware component, apparatus, or the like. The terms “apparatus” and “system” will be used synonymously. Needless to say, the term “system” will exclude a mere social “structure” (social system) arranged by humans.

Further, each process performed by each module or each of plural processes performed in the module normally involves reading target information from a storage device and writing the result of the process in the storage device after the execution of the process. Therefore, description of reading from the storage device before the process and writing in the storage device after the process may be omitted. Herein, the storage device may be a hard disk, a random access memory (RAM), an external storage medium, a storage device connected via a communication line, or registers in a central processing unit (CPU), for example.

An information processing apparatus 100 of the exemplary embodiment presents a time period suitable for personal use of an image processing apparatus that may be used for both non-personal purposes and personal purposes. As illustrated in an example of FIG. 1, the information processing apparatus 100 includes a meeting participant combination extracting module 110, a use frequency extracting module 120, a use time extracting module 130, an available time calculating module 140, an attendance and absence information extracting module 150, and a schedule information extracting module 160.

In recent years, sharing instead of personal ownership, such as car sharing, has been increasingly applied to various properties. In work environments such as offices, the use of personal items such as devices in companies has been increasing, as referred to as bring-your-own-device (BYOD).

As to a common image processing apparatus (such as a copier, a facsimile machine, a scanner, a printer, or a multifunction machine serving as an image processing apparatus having the functions of two or more of a scanner, a printer, a copier, and a facsimile machine) in an office, however, sharing between a company and individuals (for private use) has not been established. As well as an issue of charging, the consciousness (mindset) of individuals is considered as a possible reason therefor. Specifically, when a user is printing a personal (private) document by using the image processing apparatus personally (for personal or private use), another user may print a document for work. When such a situation is expected, the user refrains from personally using the image processing apparatus so as not to disrupt work.

To reduce psychological burden on users in printing documents for private purposes, for example, the exemplary embodiment presents the time period suitable for the personal use by estimating an available time of the image processing apparatus.

The meeting participant combination extracting module 110 is connected to the use frequency extracting module 120 and the use time extracting module 130. The meeting participant combination extracting module 110 extracts, from a schedule of users who use the image processing apparatus, combinations of users who will not use the image processing apparatus and time periods in which the combinations occur. Herein, the “schedule of users who use the image processing apparatus” is a schedule for the future, such as the next week or month from the present moment or the day including the present moment, for example. That is, the “schedule of users who use the image processing apparatus” is a schedule used to present the time period suitable for the personal use of the image processing apparatus and including the time period. Further, the “combinations of users who will not use the image processing apparatus” may be the participants of the same meeting, for example. This is because users normally do not use the image processing apparatus while attending a meeting.

The use frequency extracting module 120 is connected to the meeting participant combination extracting module 110 and the available time calculating module 140. The use frequency extracting module 120 extracts a history concerning non-personal use of the image processing apparatus. With the history, the use frequency extracting module 120 calculates, for each of the combinations of users, the use frequency in each of time periods of past use of the image processing apparatus.

The use time extracting module 130 is connected to the meeting participant combination extracting module 110 and the available time calculating module 140. The use time extracting module 130 extracts a history concerning non-personal use of the image processing apparatus. With the history, the use time extracting module 130 calculates, for each of the combinations of users, the use time in each of time periods of past use of the image processing apparatus.

The period of the history extracted by the use frequency extracting module 120 or the use time extracting module 130 is a predetermined period (such as the past week up to the present moment). Further, the history includes at least users and dates and times of use (which may be year, month, day, hour, minute, second, a unit less than a second, or a combination of two or more of these units). To acquire the history of each of the users (more accurately, information capable of uniquely identifying the user in the exemplary embodiment, such as user identification (ID)), the user may be instructed to input the user ID and a password, for example, when using the image processing apparatus. Further, an integrated circuit (IC) card or the like storing information of the user may be read, or the user may be subjected to facial recognition, for example. Further, the distinction between the personal use and the non-personal use may be made based on a report transmitted by the user when using the image processing apparatus or analysis of the target document. For example, a panel of the image processing apparatus may display a button for reporting the personal use, and the personal use may be stored as part of the history if the button is selected. Further, the non-personal use may be determined if the document to be printed contains any predetermined term (term used in business, such as the name of the company, for example). Conversely, the non-personal use may be determined if the document to be printed does not contain any predetermined term (term suggesting the personal use, such as “personal use,” for example). In addition to documents to be printed, documents to be scanned and documents to be copied, for example, may be included in the documents to be analyzed with a character recognition technique.

The available time calculating module 140 is connected to the use frequency extracting module 120, the use time extracting module 130, the attendance and absence information extracting module 150, and the schedule information extracting module 160. The available time calculating module 140 selects, from the schedule, a time period in which the use frequency or the use time satisfies a predetermined condition as the time period suitable for the personal use of the image processing apparatus. The available time calculating module 140 then presents the selected time period to the users. Herein, the “predetermined condition” may be that the value of the use frequency or the use time is the minimum value, equal to or less than a predetermined threshold, or at or above a predetermined rank when sorted in ascending order. Further, the “time period suitable for the personal use of the image processing apparatus” is synonymous with the “time period in which the image processing apparatus is not frequently used for the non-personal purposes (used for work).”

The attendance and absence information extracting module 150 is connected to the available time calculating module 140. The attendance and absence information extracting module 150 extracts information concerning the attendance and absence of the users.

Further, the available time calculating module 140 may select the time period by using the information concerning the attendance and absence of the users extracted by the attendance and absence information extracting module 150. The attendance and absence information may be the work arrival time and the work departure time, or may be statistical values using the work arrival time and the work departure time. For example, the mean, median, or mode work arrival time and the mean, median, or mode work departure time may be calculated from the work arrival times and the work departure times in a predetermined period (specifically, the most recent six months, for example). For example, the time period after the work departure time and before the work arrival time of a user may be selected as the time period in which the image processing apparatus will not be used by the user (specifically, the time period in which a meeting will take place).

The schedule information extracting module 160 is connected to the available time calculating module 140. The schedule information extracting module 160 extracts information concerning out-of-office engagement or leave in the schedule of the users.

Further, the available time calculating module 140 may select the time period by using the information concerning out-of-office engagement or leave in the schedule of the users extracted by the schedule information extracting module 160. For example, if the time from the end time of out-of-office engagement to the work departure time is equal to or shorter than a predetermined time, the time from the end time of the out-of-office engagement to the work departure time may also be selected as the time period in which the image processing apparatus will not be used by the user.

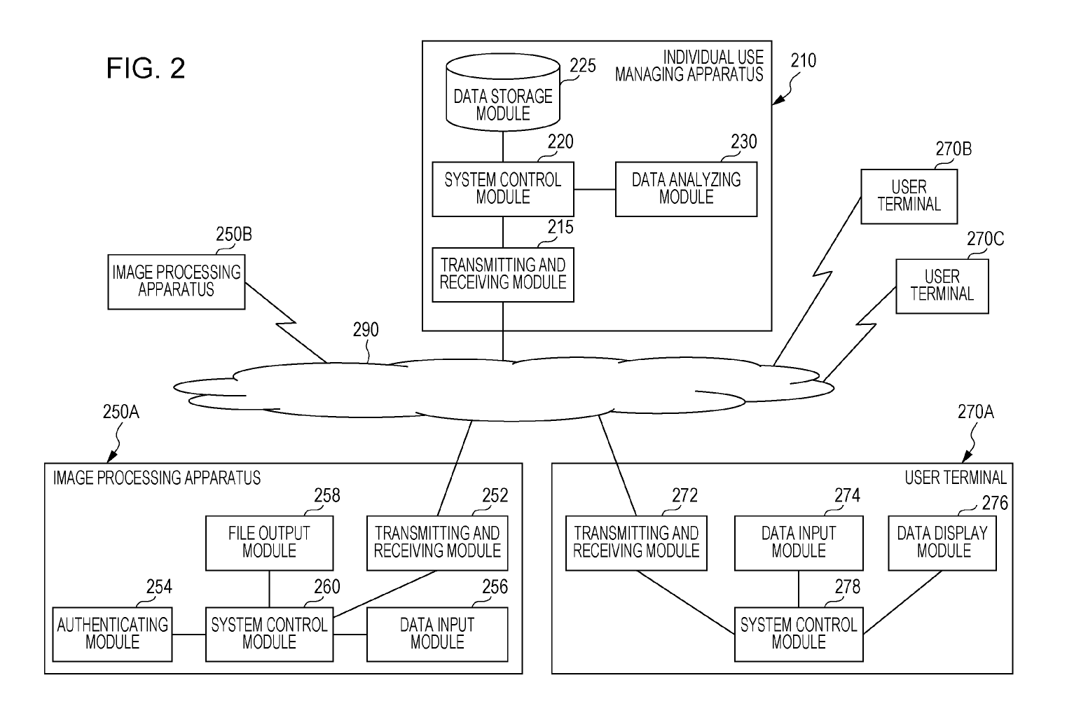

FIG. 2 is an explanatory diagram illustrating a system configuration example using the exemplary embodiment.

Herein, an example is illustrated in which an individual use managing apparatus 210, image processing apparatuses 250, and user terminals 270 are connected via a communication line 290. The communication line 290 may be wireless, wired, or a combination thereof, and may be the Internet or an intranet, for example, which serves as a communication infrastructure.

The individual use managing apparatus 210 has the functions of the information processing apparatus 100 illustrated in the example of FIG. 1. Each of the image processing apparatuses 250 is an image processing apparatus that may be used for both non-personal purposes and personal purposes and collects and transmits the history thereof to the individual use managing apparatus 210. The user terminals 270 are terminals used by the users of the image processing apparatuses 250, and may each be a personal computer (PC), a mobile information terminal such as a smartphone or a mobile phone, or a bulletin board system serving as a display, for example. The respective time periods suitable for the personal use of the image processing apparatuses 250 are presented on a display, such as a liquid crystal display, of each of the user terminals 270. Further, the schedule information, the attendance and absence information, and so forth of the users are transmitted to the individual use managing apparatus 210. Although the present example illustrates two image processing apparatuses 250A and 250B as the image processing apparatuses 250 and three user terminals 270A, 270B, and 270C as the user terminals 270, it suffices if at least one image processing apparatus 250 and at least one user terminal 270 are provided.

The individual use managing apparatus 210 includes a transmitting and receiving module 215, a system control module 220, a data storage module 225, and a data analyzing module 230. The individual use managing apparatus 210 may function as a server, or may realize the functions of the information processing apparatus 100 as a cloud service.

The transmitting and receiving module 215 is connected to the system control module 220, and is also connected to a transmitting and receiving module 252 of the image processing apparatus 250A, a transmitting and receiving module of the image processing apparatus 250B, a transmitting and receiving module 272 of the user terminal 270A, a transmitting and receiving module of the user terminal 270B, and a transmitting and receiving module of the user terminal 270C via the communication line 290. The transmitting and receiving module 215 communicates with the image processing apparatuses 250 and the user terminals 270.

The system control module 220 is connected to the transmitting and receiving module 215, the data storage module 225, and the data analyzing module 230. The system control module 220 controls the entire individual use managing apparatus 210 and the modules in the individual use managing apparatus 210.

The data storage module 225 is connected to the system control module 220. The data storage module 225 stores data necessary for the processing of the data analyzing module 230, such as the history information of the image processing apparatuses 250 and the schedule information, the attendance and absence information, and so forth of the users, for example.

The data analyzing module 230 is connected to the system control module 220. The data analyzing module 230 has the module configuration of the information processing apparatus 100.

The image processing apparatus 250A includes the transmitting and receiving module 252, an authenticating module 254, a data input module 256, a file output module 258, and a system control module 260.

The transmitting and receiving module 252 is connected to the system control module 260, and is also connected to the transmitting and receiving module 215 of the individual use managing apparatus 210, the transmitting and receiving module of the image processing apparatus 250B, the transmitting and receiving module 272 of the user terminal 270A, the transmitting and receiving module of the user terminal 270B, and the transmitting and receiving module of the user terminal 270C via the communication line 290. The transmitting and receiving module 252 communicates with the individual use managing apparatus 210 and the user terminals 270. For example, the transmitting and receiving module 252 receives a print instruction from one of the user terminals 270 and transmits the history to the individual use managing apparatus 210.

The authenticating module 254 is connected to the system control module 260. The authenticating module 254 authenticates each user who uses the image processing apparatus 250A. For example, the authenticating module 254 reads an IC card or the like and records the result of authentication (user ID, for example) as the history.

The data input module 256 is connected to the system control module 260. The data input module 256 has functions of a scanner, and preforms image reading in a copier, a facsimile machine, or a scanner. The data input module 256 may also have functions of a user interface for selecting a file to be output.

The file output module 258 is connected to the system control module 260. The file output module 258 has functions of a printer, and performs image output (printing) in a copier, a facsimile machine, or a printer.

The system control module 260 is connected to the transmitting and receiving module 252, the authenticating module 254, the data input module 256, and the file output module 258. The system control module 260 controls the entire image processing apparatus 250A and the modules in the image processing apparatus 250A. For example, the system control module 260 stores and transmits the history of the image processing apparatus 250A to the individual use managing apparatus 210.

The image processing apparatus 250B has a configuration similar to that of the image processing apparatus 250A.

The user terminal 270A includes the transmitting and receiving module 272, a data input module 274, a data display module 276, and a system control module 278.

The transmitting and receiving module 272 is connected to the system control module 278, and is also connected to the transmitting and receiving module 215 of the individual use managing apparatus 210, the transmitting and receiving module 252 of the image processing apparatus 250A, the transmitting and receiving module of the image processing apparatus 250B, the transmitting and receiving module of the user terminal 270B, and the transmitting and receiving module of the user terminal 270C via the communication line 290. The transmitting and receiving module 272 communicates with the individual use managing apparatus 210 and the image processing apparatuses 250. For example, the transmitting and receiving module 272 transmits a print instruction to one of the image processing apparatuses 250, transmits the schedule information to the individual use managing apparatus 210, and receives the result of processing (the respective time periods suitable for the personal use of the image processing apparatuses 250) from the individual use managing apparatus 210.

The data input module 274 is connected to the system control module 278. The data input module 274 has functions of input devices, such as a keyboard, a mouse, or a touch panel. For example, the data input module 274 receives an input of a schedule, a print instruction, and so forth. Specifically, the data input module 274 is a user interface of a browser or a printer driver, for example.

The data display module 276 is connected to the system control module 278. The data display module 276 has functions of a display, such as a liquid crystal display. Further, the data display module 276 may be a speaker that outputs audio, for example. Specifically, the data display module 276 is a browser, for example.

The system control module 278 is connected to the transmitting and receiving module 272, the data input module 274, and the data display module 276. The system control module 278 controls the entire user terminal 270A and the modules in the user terminal 270A. For example, the system control module 278 displays the information transmitted from the individual use managing apparatus 210 on the data display module 276.

Each of the user terminals 270B and 270C has a configuration similar to that of the user terminal 270A.

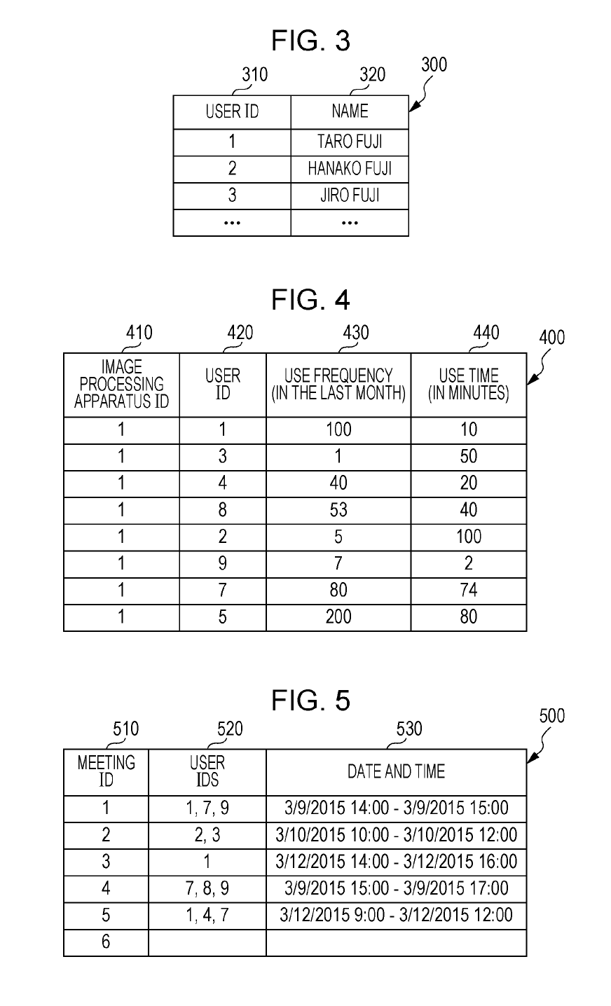

FIG. 3 is an explanatory diagram illustrating a data structure example of a user table 300. The user table 300 is stored in the data storage module 225.

The user table 300 includes a user ID field 310 and a name field 320. In the exemplary embodiment, the user ID field 310 stores information for uniquely identifying each of the users (user ID). The name field 320 stores the name of the user. Further, if the users of the image processing apparatuses are determined, another field may be provided to store information of the image processing apparatus associated with each of the users (more accurately, information capable of uniquely identifying the image processing apparatus in the exemplary embodiment, such as an image processing apparatus ID). If the field for storing the information of the image processing apparatus is provided, the image processing apparatus presented as available to the user for the personal use may be limited to the image processing apparatus associated with the user.

FIG. 4 is an explanatory diagram illustrating a data structure example of a use frequency table 400. The use frequency table 400 is stored in the data storage module 225.

The use frequency table 400 includes an image processing apparatus ID field 410, a user ID field 420, a use frequency (in the last month) field 430, and a use time (in minutes) field 440. In the exemplary embodiment, the image processing apparatus ID filed 410 stores the information for uniquely identifying each of the image processing apparatuses (image processing apparatus ID). The user ID field 420 stores the user ID of each of users having used the image processing apparatus. The use frequency (in the last month) field 430 stores the frequency of use in the last month of the image processing apparatus by the user. The use time (in minutes) field 440 stores the time of use (in minutes) in the last month of the image processing apparatus by the user. The use frequency (in the last month) field 430 and the use time (in minutes) field 440, however, do not store information of personal uses, and respectively store the frequency and the time of non-personal uses (uses for work).

FIG. 5 is an explanatory diagram illustrating a data structure example of a schedule table 500. The schedule table 500 is generated from the schedule information and stored in the data storage module 225.

The schedule table 500 includes a meeting ID field 510, a user IDs field 520, and a date and time field 530. In the exemplary embodiment, the meeting ID field 510 stores information for uniquely identifying each of meetings (meeting ID). The user IDs field 520 stores the user ID of each user who will attend the meeting. The date and time field 530 stores the date and time in which the meeting will be held.

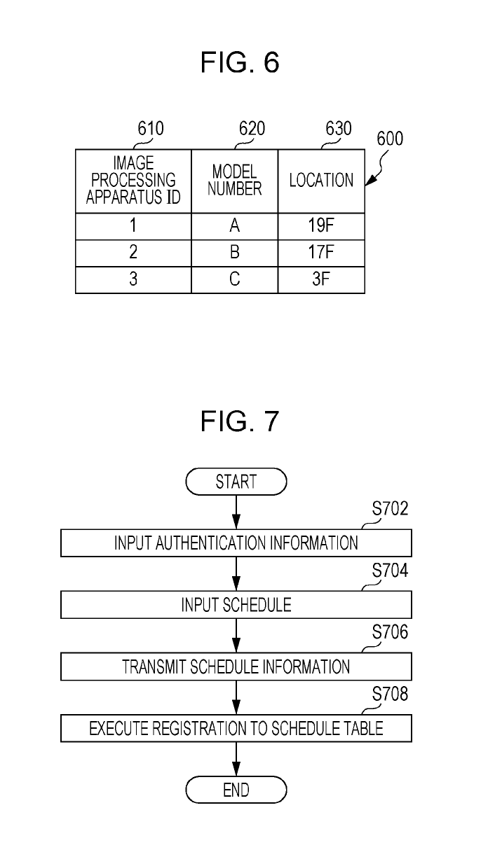

FIG. 6 is an exemplary diagram illustrating a data structure example of an image processing apparatus table 600. The image processing apparatus table 600 is stored in the data storage module 225.

The image processing apparatus table 600 includes an image processing apparatus ID filed 610, a model number field 620, and a location field 630. The image processing apparatus ID filed 610 stores the image processing apparatus ID of each of the image processing apparatuses. The model number field 620 stores the model number of the image processing apparatus. The location field 630 stores the location in which the image processing apparatus is installed.

FIG. 7 is a flowchart illustrating an example of processing according to the exemplary embodiment (each of the user terminals 270 and the individual use managing apparatus 210).

At step S702, authentication information is input through an operation by the user. For example, the user ID and the password, for example, are input with the user terminal 270.

At step S704, a schedule is input through an operation by the user. For example, a future plan (such as a meeting, for example) is input with the user terminal 270, with the date and time of the plan specified.

At step S706, the user terminal 270 transmits the schedule information to the individual use managing apparatus 210 (the information processing apparatus 100).

At step S708, the individual use managing apparatus 210 executes registration to the schedule table 500 in the data storage module 225 based on the schedule information. In this case, as illustrated in the example of FIG. 5, the meeting ID (which may be the meeting name, for example) is stored in the meeting ID field 510, and the user ID representing the user having transmitted the schedule information is stored in the user IDs field 520. Further, the scheduled time period of the meeting is stored in the date and time field 530. This time period is a candidate for the time period suitable for the personal use of the image processing apparatus. This is because, during the meeting, the image processing apparatus is unlikely to be used by the user attending the meeting.

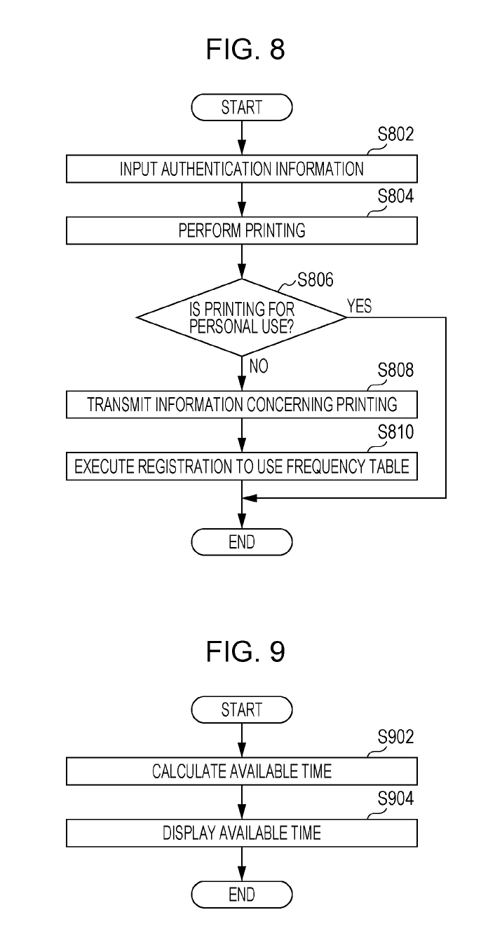

FIG. 8 is a flowchart illustrating an example of processing according to the exemplary embodiment (each of the image processing apparatuses 250 and the individual use managing apparatus 210).

At step S802, authentication information is input through an operation by the user. For example, the image processing apparatus 250 reads the IC card.

At step S804, the image processing apparatus 250 performs a printing process in accordance with an operation by the user.

At step S806, whether or not the printing is for the personal use is determined. If the printing is for the personal use, the process is completed. If not, the procedure proceeds to step S808. As described above, this determination is made based on the operation by the user (operation of a report button for reporting that the printing is for the personal use, for example) or the analysis of the document.

At step S808, the image processing apparatus 250 transmits information concerning the printing to the individual use managing apparatus 210 (the information processing apparatus 100). The sum of use frequencies and the sum of use times may be transmitted in each predetermined period (one month, for example) or on a predetermined date (at the end of each month, for example).

At step S810, the individual use managing apparatus 210 executes registration to the use frequency table 400 in the data storage module 225. In this case, as illustrated in the example of FIG. 4, the image processing apparatus ID of the image processing apparatus 250 is stored in the image processing apparatus ID field 410, and the user ID representing the user having used the image processing apparatus 250 is stored in the user ID field 420. Further, the use frequency is stored in the use frequency (in the last month) field 430, and the use time is stored in the use time (in minutes) field 440.

FIG. 9 is a flowchart illustrating an example of processing according to the exemplary embodiment (the information processing apparatus 100).

At step S902, the available time calculating module 140 calculates the available time (the time period suitable for the personal use).

At step S904, the information processing apparatus 100 transmits the information concerning the calculated available time to the user terminals 270, and the user terminals 270 display the available time.

Specific examples will be described.

### First Specific Example

The time period suitable for the personal use is calculated with the use frequency.

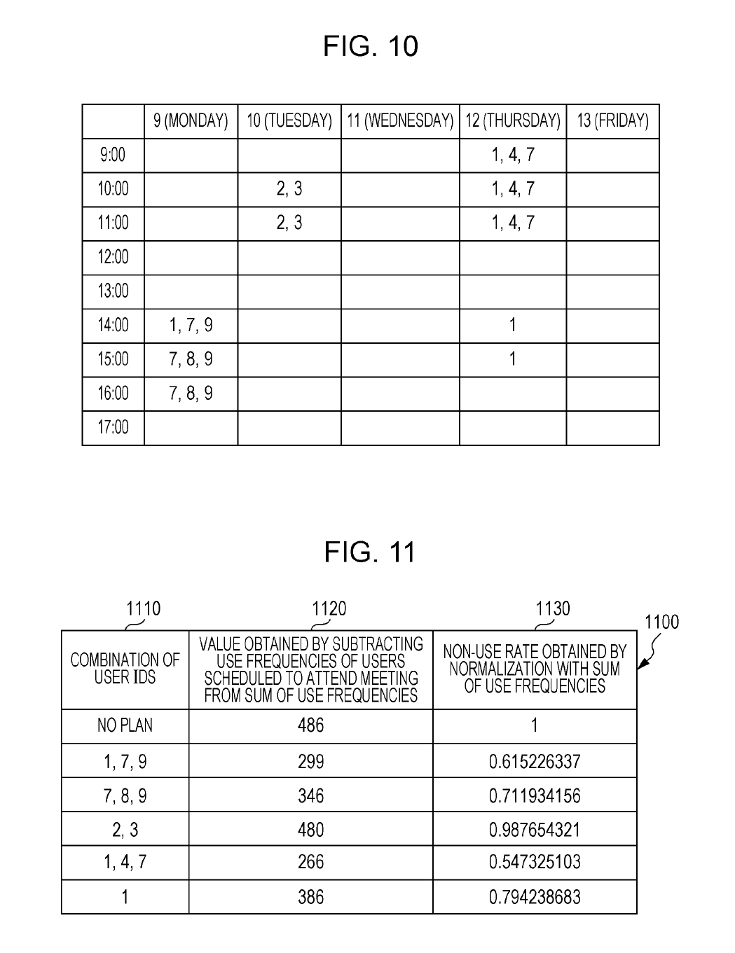

One of the image processing apparatuses 250 is used by ten users (user IDs 1 to 10). Based on the schedule table 500, the meeting schedule for the second week of March, 2015 is presented in the example illustrated in FIG. 10. Numbers in the schedule (1 to 10) represent the user IDs and indicate that, in a time period with any of the user IDs, the user with the user ID will attend a meeting in the time period. For example, it is indicated that two users corresponding to the user IDs 2 and 3 will attend a meeting from 10:00 to 12:00 on 10th.

Weighting is performed based on the use frequency in the use frequency table 400.

One use of the image processing apparatus is counted as one, and normalization is performed with the sum total of use frequencies of the users having used the image processing apparatus with the image processing apparatus ID of 1. The result of this process is presented in the example illustrated in FIG. 11. FIG. 11 is an explanatory diagram illustrating a data structure example of a use frequency related information table 1100. The use frequency related information table 1100 includes a field 1110 of the combination of user IDs, a field 1120 of the value obtained by subtracting the use frequencies of the users scheduled to attend a meeting from the sum of use frequencies, and a field 1130 of the non-use rate obtained by normalization with the sum of use frequencies. The field 1110 of the combination of user IDs stores the combination of user IDs. The field 1120 of the value obtained by subtracting the use frequencies of the users scheduled to attend a meeting from the sum of use frequencies stores the value obtained by subtracting the use frequencies of the users scheduled to attend a meeting (the users with the user IDs in the field 1110 of the combination of user IDs) from the sum of use frequencies. The field 1130 of the non-use rate obtained by normalization with the sum of use frequencies stores the non-use rate obtained by normalization with the sum of use frequencies.

The field 1110 of the combination of user IDs presents the types of combinations of users scheduled to attend a meeting in the schedule for the second week of March, 2015. A cell with no plan taken into account is described as NO PLAN.

The field 1120 of the value obtained by subtracting the use frequencies of the users scheduled to attend a meeting from the sum of use frequencies presents the use frequency in the last month of the image processing apparatus with the image processing apparatus ID of 1. The sum total of use frequencies is 486 (in the first row corresponding to “NO PLAN” in the field 1110 of the combination of user IDs). Further, the value obtained by subtracting the use frequencies of the users with the user IDs 1, 7, and 9 from the sum total is 299 (in the second row corresponding to “1, 7, 9” in the field 1110 of the combination of user IDs). The smaller this value is, the higher frequency of use by these users is indicated.

The field 1130 of the non-use rate obtained by normalization with the sum of use frequencies presents the value obtained by dividing the value of the field 1120, that is, the value obtained by subtracting the use frequencies of the users scheduled to attend a meeting from the sum of use frequencies, by the sum total of use frequencies. That is, the field 1130 of the non-use rate obtained by normalization with the sum of use frequencies presents a normalized value. The smaller this value is, the more likely the corresponding time period is to become an available time, since these users are unable to use the image processing apparatus with the image processing apparatus ID of 1 when attending a meeting.

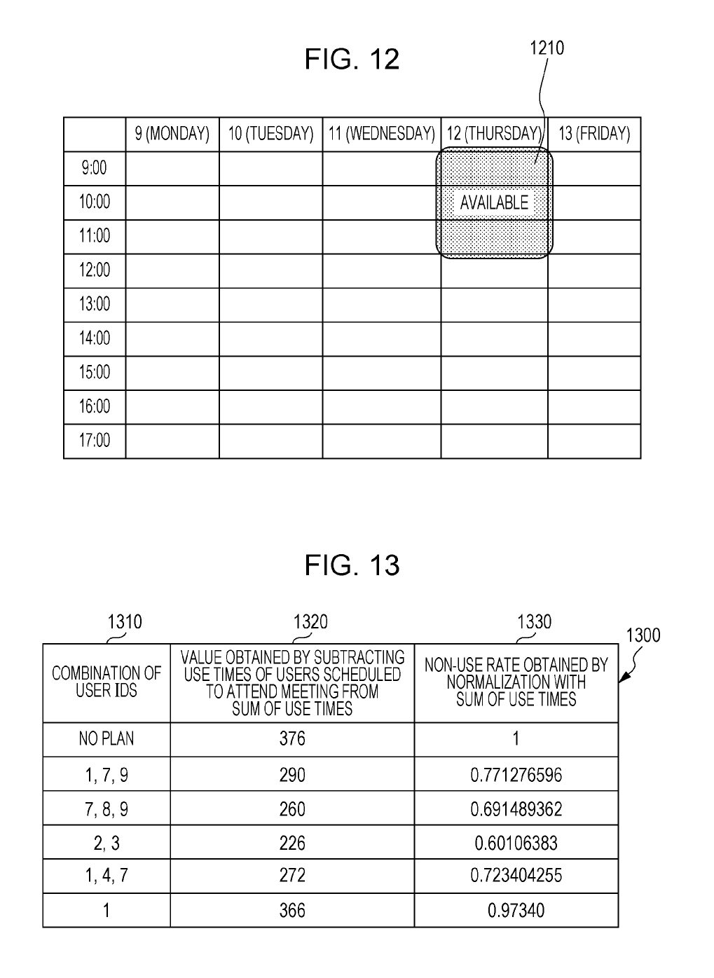

The available time calculating module 140 extracts the row with the smallest value in the field 1130 of the non-use rate obtained by normalization with the sum of use frequencies in the use frequency related information table 1100 (the fifth row), and extracts the corresponding user IDs (1, 4, and 7) in the field 1110 of the combination of user IDs. The available time calculating module 140 then extracts from the schedule table 500 the time period of the meeting to be attended by the users with these user IDs. That is, the image processing apparatus with the image processing apparatus ID of 1 will be used least frequently in the time period in which the users with the user IDs 1, 4, and 7 will attend the meeting (9:00 to 12:00 on Mar. 12, 2015). The individual use managing apparatus 210 transmits this information to each of the user terminals 270, and the user terminal 270 displays a calendar on the browser and displays an available field 1210 on the calendar, for example, as illustrated in FIG. 12. Although one available time period is presented in the example of FIG. 12, plural candidates may be displayed in different colors, for example. For instance, the time periods corresponding to the values in the field 1130 of the non-use rate obtained by normalization with the sum of use frequencies smaller than a predetermined threshold may be selectively displayed. Further, the values in the field 1130 of the non-use rate obtained by normalization with the sum of use frequencies may be sorted in ascending order, and a predetermined number of the smallest values may be selectively displayed. Since the field 1110 of the combination of user IDs presents combinations of meeting participants in the schedule information, the combinations of users are associated with one or more meetings.

Further, for each of the users to whom the available time is transmitted, whether or not the user will attend a meeting in the available time period may be determined. Then, if the user will attend a meeting in the available time period, another available time period as the next candidate (the time period corresponding to the second smallest value in the field 1130 of the non-use rate obtained by normalization with the sum of use frequencies) may be selected and transmitted. That is, for each of the users, the time of a meeting that will not be attended by the user (available time) may be selected.

### Second Specific Example

The time period suitable for the personal use is calculated with the use time.

This is an example in which the use frequency in the first specific example is replaced by the use time. The normalization is performed with the sum of use times. The result of this process is presented in the example illustrated in FIG. 13. FIG. 13 is an explanatory diagram illustrating a data structure example of a use time related information table 1300. The use time related information table 1300 includes a field 1310 of the combination of user IDs, a field 1320 of the value obtained by subtracting the use times of the users scheduled to attend a meeting from the sum of use times, and a field 1330 of the non-use rate obtained by normalization with the sum of use times. The field 1310 of the combination of user IDs stores the combination of user IDs, and is equivalent to the field 1110 of the combination of user IDs in the use frequency related information table 1100. The field 1320 of the value obtained by subtracting the use times of the users scheduled to attend a meeting from the sum of use times stores the value obtained by subtracting the use times of the users scheduled to attend a meeting from the sum of use times. The field 1330 of the non-use rate obtained by normalization with the sum of use times stores the non-use rate obtained by normalization with the sum of use times. A reduction in the value of the field 1320, that is, the value obtained by subtracting the use times of the users scheduled to attend a meeting from the sum of use times, indicates an increase in the time of use by these users. The smaller the value in the field 1330 of the non-use rate obtained by normalization with the sum of use times is, the more likely the corresponding time period is to become an available time, since these users are unable to use the image processing apparatus with the image processing apparatus ID of 1 when attending a meeting.

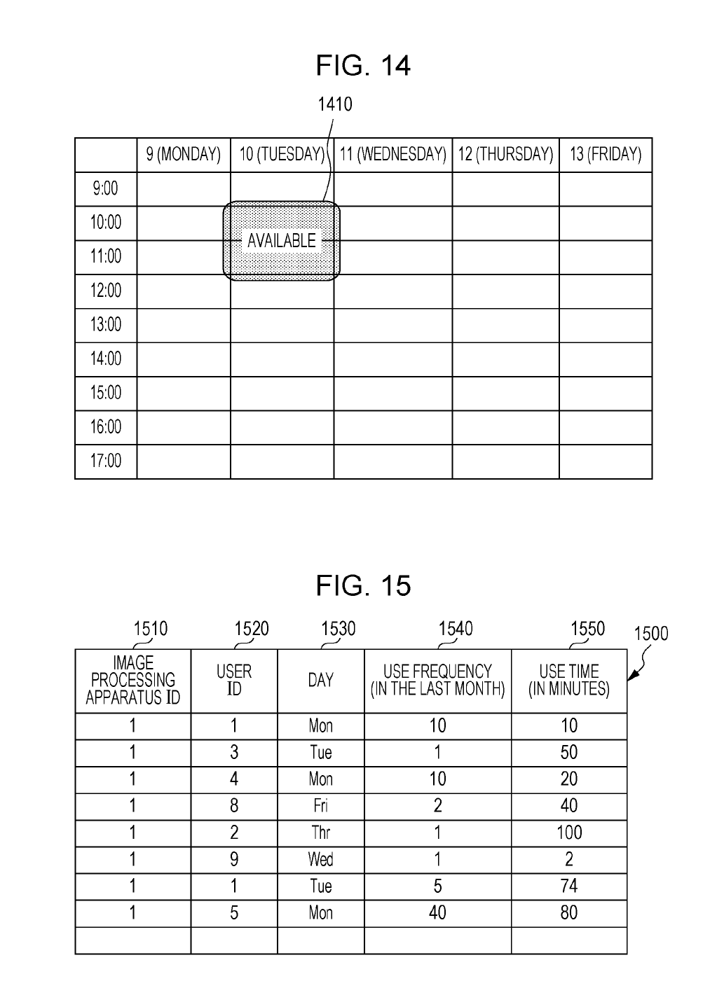

The available time calculating module 140 extracts the row with the smallest value in the field 1330 of the non-use rate obtained by normalization with the sum of use times in the use time related information table 1300 (the fourth row), and extracts the corresponding user IDs (2 and 3) in the field 1310 of the combination of user IDs. The available time calculating module 140 then extracts from the schedule table 500 the time period of the meeting to be attended by the users with these user IDs. That is, the image processing apparatus with the image processing apparatus ID of 1 will be used least in the time period in which the users with the user IDs 2 and 3 will attend the meeting (10:00 to 12:00 on Mar. 10, 2015). The individual use managing apparatus 210 transmits this information to each of the user terminals 270, and the user terminal 270 displays a calendar on the browser and displays an available field 1410 on the calendar, for example, as illustrated in FIG. 14. Although one available time period is presented in the example of FIG. 14, plural candidates may be displayed in different colors, for example. For instance, the time periods corresponding to the values in the field 1330 of the non-use rate obtained by normalization with the sum of use times smaller than a predetermined threshold may be selectively displayed. Further, the values in the field 1330 of the non-use rate obtained by normalization with the sum of use times may be sorted in ascending order, and a predetermined number of the smallest values may be selectively displayed. Since the field 1310 of the combination of user IDs presents combinations of meeting participants in the schedule information, the combinations of users are associated with one or more meetings.

Further, for each of the users to whom the available time is transmitted, whether or not the user will attend a meeting in the available time may be determined. Then, if the user will attend a meeting in the available time, another available time period as the next candidate (the time period corresponding to the second smallest value in the field 1330 of the non-use rate obtained by normalization with the sum of use times) may be selected and transmitted. That is, for each of the users, the time of a meeting that will not be attended by the user (available time) may be selected.

### Third Specific Example

The time period suitable for the personal use is calculated with both the use frequency and the use time.

When only the use time is taken into account, as in the second specific example, the weight is substantially increased if a file of a substantially large file size is printed just once, for example. The same is true of the case in which only the use frequency is taken into account, as in the first specific example. Accordingly, the process is performed with the combination of two factors of the use time and the use frequency.

For example, an image processing apparatus use frequency table 1500 is used. FIG. 15 is an explanatory diagram illustrating a data structure example of the image processing apparatus use frequency table 1500. The image processing apparatus use frequency table 1500 includes an image processing apparatus ID field 1510, a user ID field 1520, a day field 1530, a use frequency (in the last month) field 1540, and a use time (in minutes) field 1550. The image processing apparatus ID field 1510 stores the image processing apparatus ID. The user ID field 1520 stores the user ID of the user having used the image processing apparatus with the image processing apparatus ID. The day field 1530 stores the day of the use of the image processing apparatus. The use frequency (in the last month) field 1540 stores the frequency of use of the image processing apparatus by the user on the day in the last month. The use time (in minutes) field 1550 stores the time of use (in minutes) of the image processing apparatus by the user on the day.

That is, the image processing apparatus use frequency table 1500 has the columns of the use frequency table 400 and an additional column of day to store data for each day. With this configuration, whether or not the user regularly outputs prints for work is determined. An unexpected print may be exempted from inclusion in the weighting calculation formula.

For example, in the image processing apparatus use frequency table 1500 illustrated in FIG. 15, the rows in which the use frequency is four (an example of a predetermined value) or less, that is, the second, fourth, fifth, and sixth rows, are exempted. Therefore, the values in the first, third, seventh, and eighth rows are used to calculate the available time. That is, the sum of times of use by the user on each day is calculated, and the normalization is performed with the value of the sum. Thereafter, a process similar to that of the second specific example is performed.

Further, the rows in which the use time is 40 (an example of a predetermined value) or less, that is, the first, third, fourth, and sixth rows, are exempted. Therefore, the values in the second, fifth, seventh, and eighth rows are used to calculate the available time. That is, the sum of frequencies of use by the user on each day is calculated, and the normalization is performed with the value of the sum. Thereafter, a process similar to that of the first specific example is performed.

### Fourth Specific Example

The time period suitable for the personal use is calculated with the attendance and absence information.

The use of the attendance and absence information enables measurement of a more accurate available time. According to the first and second specific examples, if no meeting is set in the schedule, it is determined that the image processing apparatus may be used. Therefore, an out-of-office time in which the user is out of the office is not determined as the available time.

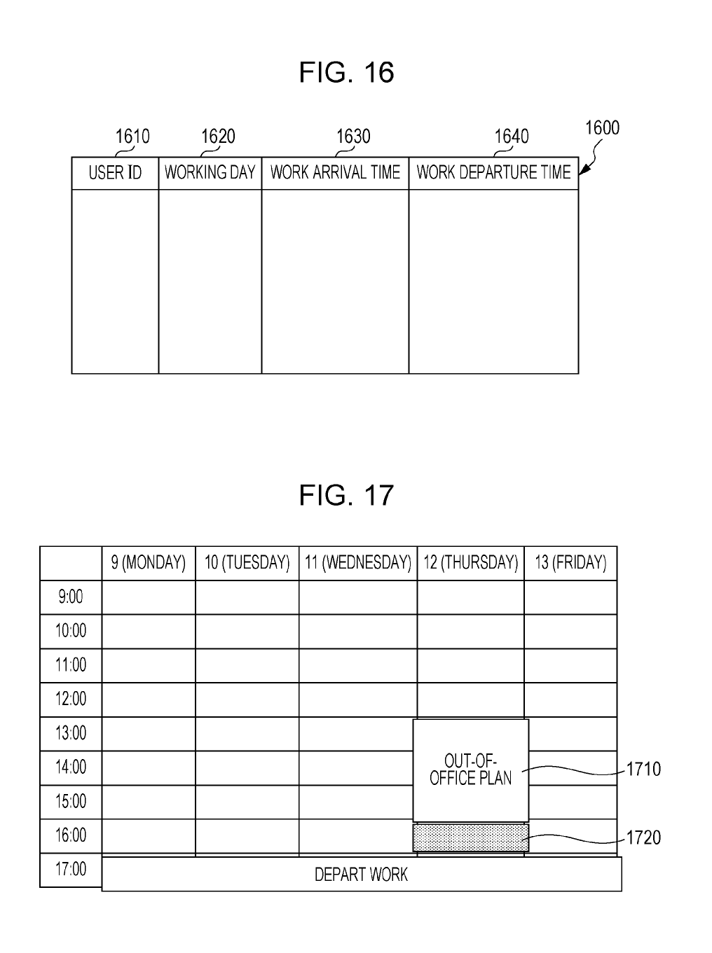

In view of the above, the attendance and absence in a predetermined period (six months, for example) is acquired from the attendance and absence information of the user, and the average work arrival time and the average work departure time are calculated, for example. For instance, a work arrival and departure information table 1600 is acquired from a work arrival and departure system. FIG. 16 is an explanatory diagram illustrating a data structure example of the work arrival and departure information table 1600. The work arrival and departure information table 1600 includes a user ID field 1610, a working day field 1620, a work arrival time field 1630, and a work departure time field 1640. The user ID field 1610 stores the user ID. The working day field 1620 stores working days of the user with the user ID. The work arrival time field 1630 stores the work arrival time on each of the working days of the user. The work departure time field 1640 stores the work departure time on each of the working days of the user. The work arrival times and the work departure times in the predetermined period may be extracted for each user to calculate the respective average values of the work arrival times and the work departure times. Further, the time period after the average work departure time and before the average work arrival time may be handled as the time period scheduled for a meeting.

In this case, the time after the average work departure time and before the average work arrival time emerges as a candidate accounting for most of the available time. Therefore, the user may be instructed to specify a desired use time, and the time period suitable for the personal use may be calculated within the desired use time. Further, the time period suitable for the personal use may be calculated for each user within the period from the average work arrival time to the average work departure time.

### Fifth Specific Example

The time period suitable for the personal use is calculated with a character string in the schedule.

For example, if the user needs to leave the office for a meeting that will be held outside the company, the user may put an entry OUT OF OFFICE in the schedule. Since the user will not use the image processing apparatus when out of the office, the time period in the schedule with the entry OUT OF OFFICE may be handled similarly to the time period of a meeting. The time period with an entry LEAVE may also be handled similarly to the time period of a meeting.

Further, in the case of out-of-office engagement, if the work departure time (which may be the work departure time determined by each company or the foregoing average work departure time of each user) is close to the out-of-office time, the user may directly go home without returning to the office (so-called straight back home). An example of such a case is when a time period 1720 from the end time of an out-of-office plan 1710 to the work departure time is less than one hour, as illustrated in FIG. 17. In that case, the period between the out-of-office engagement and the work departure time may also be handled similarly to the time period of a meeting. Specifically, if the schedule includes the entry OUT OF OFFICE, and if the period from the end time of the out-of-office engagement to the work departure time is shorter than a predetermined threshold, the time period from the start time of the out-of-office engagement (that is, which may include the time period from the end time of the out-of-office engagement to the work departure time and also the time period after the work departure time) may be handled similarly to the time period of a meeting.

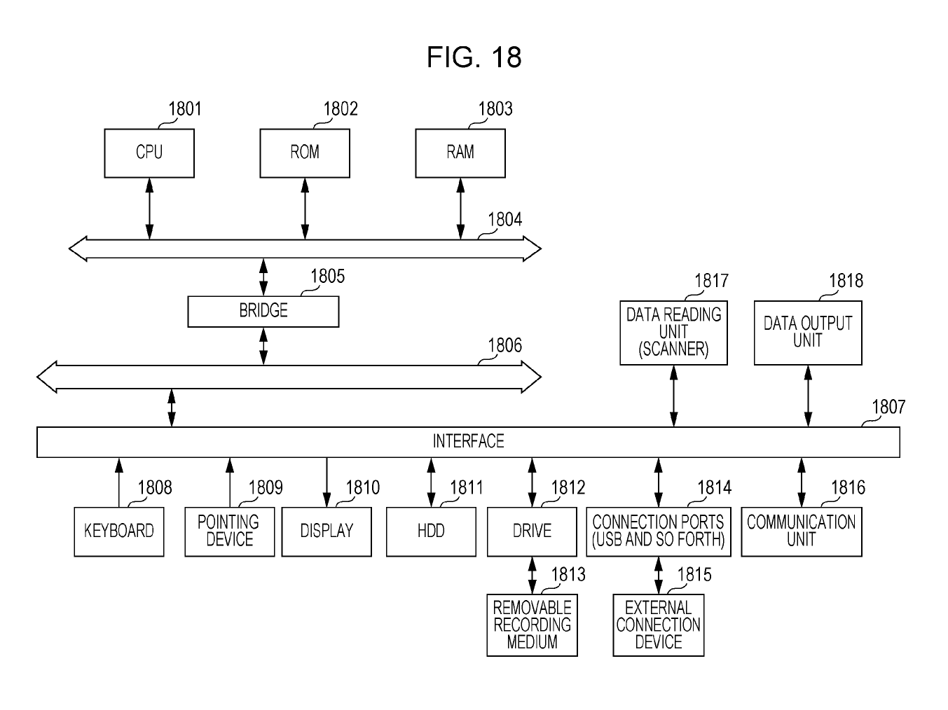

A hardware configuration example of the information processing apparatus 100 according to the exemplary embodiment will be described with reference to FIG. 18. The configuration illustrated in FIG. 18 is configured of a personal computer (PC), for example. The illustrated hardware configuration example includes a data reading unit 1817 such as a scanner and a data output unit 1818 such as a printer.

A central processing unit (CPU) 1801 is a controller that executes processing according to a computer program describing an execution sequence of the various modules described in the foregoing exemplary embodiment, that is, modules such as the meeting participant combination extracting module 110, the use frequency extracting module 120, the use time extracting module 130, the available time calculating module 140, the attendance and absence information extracting module 150, the schedule information extracting module 160, the transmitting and receiving module 215, the system control module 220, the data analyzing module 230, the transmitting and receiving module 272, the data input module 274, the data display module 276, the system control module 278, the transmitting and receiving module 252, the authenticating module 254, the data input module 256, the file output module 258, and the system control module 260.

A read only memory (ROM) 1802 stores programs, arithmetic parameters, and so forth used by the CPU 1801. A random access memory (RAM) 1803 stores programs used in the execution of the CPU 1801, parameters changed as appropriate during the execution, and so forth. The CPU 1801, the ROM 1802, and the RAM 1803 are connected to one another by a host bus 1804 configured of a CPU bus or the like.

The host bus 1804 is connected to an external bus 1806, such as a peripheral component interconnect/interface (PCI) bus, via a bridge 1805.

A keyboard 1808 and a pointing device 1809 such as a mouse are input devices operated by an operator. A display 1810, such as a liquid crystal display or a cathode ray tube (CRT), displays various information as text or image information.

A hard disk drive (HDD) 1811 includes and drives a hard disk (which may be a flash memory, for example), and records or reproduces information or a program executed by the CPU 1801. The hard disk stores the use history of the image processing apparatuses 250, the schedule information of the users, the information for presenting the time period suitable for the personal use, and so forth. The hard disk further stores other various data, various computer programs, and so forth.

A drive 1812 reads data or a program recorded in a removable recording medium 1813 installed therein, such as a magnetic disk, an optical disk, a magneto-optical disk, or a semiconductor memory, and supplies the data or program to the RAM 1803 connected to the drive 1812 via an interface 1807, the external bus 1806, the bridge 1805, and the host bus 1804. The removable recording medium 1813 is also usable as a data recording area similar to the hard disk.

Connection ports 1814, which are ports for connection to an external connection device 1815, include connection units conforming to universal serial bus (USB), Institute of Electrical and Electronics Engineers (IEEE) 1394, and so forth. The connection ports 1814 are connected to the CPU 1801 and so forth via the interface 1807, the external bus 1806, the bridge 1805, the host bus 1804, and so forth. A communication unit 1816 is connected to a communication line, and executes a process of data communication with an external device. The data reading unit 1817, such as a scanner, for example, executes a process of reading a document. The data output unit 1818, such as a printer, for example, executes a process of outputting document data.

The hardware configuration of the information processing apparatus 100 illustrated in FIG. 18 is one configuration example. The exemplary embodiment is not limited to the configuration illustrated in FIG. 18, and may have any configuration capable of executing the modules described in the exemplary embodiment. For example, some of the modules may be configured of dedicated hardware (such as an application specific integrated circuit (ASIC), for example). Some of the modules may be provided in an external system and connected to the information processing apparatus 100 via a communication line. Further, the system illustrated in FIG. 18 may be provided in plurality, and the systems may be connected by a communication line to cooperate with one another. Furthermore, the modules may be incorporated particularly in a mobile telecommunications device (such as a mobile phone, a smartphone, a mobile device, and a wearable computer), an information home appliance, a robot, a copier, a facsimile machine, a scanner, a printer, a multifunction machine, and so forth, as well as in the personal computer.

Further, in the description of the foregoing exemplary embodiment, the expressions “equal to or greater than,” “equal to or smaller than,” “greater than,” and “smaller (less) than” in the comparison with a predetermined value may be paraphrased as “greater than,” “smaller (less) than,” “equal to or greater than,” and “equal to or smaller than,” respectively, as long as the expressions cause no contradictions.

Each of the above-described programs may be provided as stored in a recording medium, or may be provided by a communication unit. In that case, the foregoing program may be considered as an invention of “a computer readable recording medium recorded with a program.”

“A computer readable recording medium recorded with a program” refers to a recording medium readable by a computer and recorded with a program to be used for installation, execution, distribution, and so forth of the program.

Examples of the recording medium include a digital versatile disk (DVD), such as a standard “DVD-recordable (R),” “DVD-rewritable (RW),” or “DVD-RAM” specified by DVD Forum or a standard “DVD+R” or “DVD+RW” specified by DVD+RW Alliance, a compact disc (CD), such as a CD-ROM, a CD-R, or a CD-RW, a Blu-ray (registered trademark) disc, a magneto-optical disk (MO), a flexible disk (FD), a magnetic tape, a hard disk, a ROM, an electrically erasable programmable ROM (EEPROM) (registered trademark), a flash memory, a RAM, and a secure digital (SD) memory card.

Further, the foregoing program or a part thereof may be recorded in the foregoing recording medium to be stored or distributed, for example. The program or a part thereof may also be transmitted by communication with a transmission medium, such as a wired network, a radio communication network, or a combination thereof used in a local area network (LAN), a metropolitan area network (MAN), a wide area network (WAN), the Internet, an intranet, an extranet, or the like, for example, or may be transmitted by carrier waves.

Further, the foregoing program may be a part of another program, or may be recorded in a recording medium together with a different program. Furthermore, the program may be dividedly recorded in plural recording media. Further, the program may be recorded in any restorable form, such as a compressed or encrypted form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first extracting unit that extracts a history concerning non-personal use of an image processing apparatus;
a second extracting unit that extracts, from a schedule of users who use the image processing apparatus, combinations of users who will not use the image processing apparatus and time periods in which the combinations occur;
a third extracting unit that extracts, with the history and for each of the combinations of users, a use frequency or a use time in each of time periods of past use of the image processing apparatus; and
a selecting unit that selects from the schedule a time period in which the use frequency or the use time satisfies a predetermined condition as a time period suitable for personal use of the image processing apparatus.

2. The information processing apparatus according to claim 1, wherein the combinations of users who will not use the image processing apparatus are meeting participants.

3. The information processing apparatus according to claim 1, wherein the selecting unit selects the time period with information concerning attendance and absence of the users.

4. The information processing apparatus according to claim 2, wherein the selecting unit selects the time period with information concerning attendance and absence of the users.

5. The information processing apparatus according to claim 1, wherein the selecting unit selects the time period with information concerning out-of-office engagement or leave in the schedule of the users.

6. The information processing apparatus according to claim 2, wherein the selecting unit selects the time period with information concerning out-of-office engagement or leave in the schedule of the users.

7. The information processing apparatus according to claim 3, wherein the selecting unit selects the time period with information concerning out-of-office engagement or leave in the schedule of the users.

8. The information processing apparatus according to claim 4, wherein the selecting unit selects the time period with information concerning out-of-office engagement or leave in the schedule of the users.

9. A non-transitory computer readable medium storing a program causing a computer to execute information processing, the processing comprising:
extracting a history concerning non-personal use of an image processing apparatus;
extracting, from a schedule of users who use the image processing apparatus, combinations of users who will not use the image processing apparatus and time periods in which the combinations occur;
extracting, with the history and for each of the combinations of users, a use frequency or a use time in each of time periods of past use of the image processing apparatus; and
selecting from the schedule a time period in which the use frequency or the use time satisfies a predetermined condition as a time period suitable for personal use of the image processing apparatus.

10. An information processing method comprising:
extracting a history concerning non-personal use of an image processing apparatus;
extracting, from a schedule of users who use the image processing apparatus, combinations of users who will not use the image processing apparatus and time periods in which the combinations occur;
extracting, with the history and for each of the combinations of users, a use frequency or a use time in each of time periods of past use of the image processing apparatus; and
selecting from the schedule a time period in which the use frequency or the use time satisfies a predetermined condition as a time period suitable for personal use of the image processing apparatus.
